(19) United States
(12) Patent Application Publication
(10) Pub. No.: US 2010/0023978 A1
(43) Pub. Date: Jan. 28, 2010

(54) Method and Apparatus for Determining Broadcast Reception Requirements Based on Location

(75) Inventors: Dinesh Kumar Garg, Roorkee (IN); Manish Poddar, Burhanpur (IN)

Correspondence Address: ADVANCED MICRO DEVICES, INC.;C/O VEDDER PRICE P.C., 222 N.LASALLE STREET, CHICAGO, IL, 60601, US

(73) Assignee: ATI TECHNOLOGIES ULC, Markham (CA)

(21) Appl. No.: 12/191,064

(22) Filed: Aug. 13, 2008

(30) Foreign Application Priority Data
Jul. 28, 2008 (IN) 1808/CHE/2008

(51) Int. Cl. H04N 7/173

(52) U.S. Cl. 725/87

(57) ABSTRACT

A disclosed method comprises obtaining location data including geographic coordinates; searching stored digital video broadcast network requirements data corresponding to the location data; and tuning to a digital video broadcast network channel indicated by the digital video broadcast network requirements data. The step of obtaining location data may further comprise obtaining Global Positioning System (GPS) data; and searching using the GPS data. An integrated circuit includes tuner logic, operative to tune to, and receive, a digital video broadcast network channel in response to a command; location data logic to receive location data; digital video broadcast network reception requirements logic to obtain location data from the location data logic and search stored digital video broadcast network requirements data corresponding to the location data, and send the command to the tuner logic to tune to a digital video broadcast network channel indicated by the digital video broadcast network requirements data.

### FIELD OF THE DISCLOSURE

The present disclosure is generally related to mobile stations with digital video broadcast reception and location capability, and to software and components of such mobile stations.

### BACKGROUND

Mobile communication devices such as mobile telephones are increasingly including a capability for receiving Digital Video Broadcast signals. Digital Video Broadcast networks may be included as part of a telecommunications network or may be separate networks setup specifically for the purpose of broadcasting digital video to mobile devices. Various technologies and related standards exist for the broadcast of digital video to mobile devices, such as, but not limited to, Digital Video Broadcast DVB-H, DVB-T, etc. The various digital broadcast network technologies are, similar to a telecommunications network radio coverage area, limited to a given geographic area in terms of radio coverage. Therefore as a mobile station user moves or travels through various geographic areas, the broadcast network technology available in the given geographic area may change. The mobile station would necessarily need to perform a scanning routine either as the mobile station moves through the various geographic areas or as the mobile station is turned on or powered up within each new geographic area. Such scanning procedures not only result in a usage of mobile station battery power, but also slow down the operation of the device thereby effecting the experience of the user when attempting to view digital video.

Therefore, what is needed are methods and apparatuses to improve the mobile station's capability of determining an available digital video broadcast network technology.

### BRIEF DESCRIPTION OF THE DRAWINGS

FIG. 1 is a block diagram illustrating a mobile device having a digital video broadcast network requirements logic in accordance with the embodiments.

FIG. 2 is a flow chart illustrating a method of operation in accordance with the embodiments.

FIG. 3 is a flow chart illustrating another method of operation in accordance with the embodiments.

FIG. 4 is a flow chart illustrating a method of operation in accordance with an embodiment wherein GPS data is utilized.

### DETAILED DESCRIPTION

A method in accordance with the embodiments herein disclosed includes obtaining location data including geographic coordinates, searching stored Digital Video Broadcast network requirements data corresponding to the location data, and tuning to a Digital Video Broadcast network channel indicated by the Digital Video Broadcast network requirements data. The method may also include obtaining Global Positioning System (GPS) data; and searching the stored Digital Video Broadcast network requirements data using the GPS data. The method may also include obtaining location server data; and searching the stored Digital Video Broadcast network requirements data using the location server data.

A method in accordance with another embodiment includes obtaining location data including geographic coordinates; searching stored Digital Video Broadcast network requirements data corresponding to the location data; tuning to a Digital Video Broadcast network channel indicated by the Digital Video Broadcast network requirements data; and initializing a Protocol Stack code for a Digital Video Broadcast network technology indicated by the Digital Video Broadcast network requirements data. This method may also include determining that the Protocol Stack code is not present; requesting the Protocol Stack code from a communications network associated with the geographic coordinates; and downloading the Protocol Stack code from the communications network.

The embodiments herein disclosed also provide a mobile communications device including tuner logic, operative to tune to, and receive, a Digital Video Broadcast network channel in response to a command; location data logic, operative to receive location data, including geographic coordinates; Digital Video Broadcast network reception requirements logic, operatively coupled to the tuner logic and to the location data logic, the Digital Video Broadcast network reception requirements logic being operative to obtain location data, including geographic coordinates, from the location data logic; search stored Digital Video Broadcast network requirements data corresponding to the location data; and send the command to the tuner logic to tune to a Digital Video Broadcast network channel indicated by the Digital Video Broadcast network requirements data; and a display, operatively coupled to the tuner logic, where the display is operative to display Digital Video received by the tuner logic over the Digital Video Broadcast network channel. The mobile communication device may also include at least one of a GPS receiver, or location server data logic, for communicating with a location server to obtain the location data including geographic coordinates; and memory for storing the stored Digital Video Broadcast network requirements data. The mobile communication device may further include multi-mode manager logic, operatively coupled to the Digital Video Broadcast network reception requirements logic and to the tuner logic, where the multi-mode manager logic is operative to control the tuner logic and manage initialization and shut-down of a plurality of Protocol Stack codes, each Protocol Stack code of the plurality of the Protocol Stack codes being associated with a specific Digital Video Broadcast network technology and wherein the Digital Video Broadcast network reception logic initializes a specific Protocol Stack code for a corresponding Digital Video Broadcast network technology via the multi-mode logic. The mobile communication device may further include the Digital Video Broadcast reception requirements logic being operative to determine that a needed Protocol Stack is not present in a mobile communication device memory; request the needed Protocol Stack from a communication network associated with the geographic coordinates; and download the needed Protocol Stack from the communications network.

The embodiments disclosed herein also provide an integrated circuit including tuner logic, operative to the tune to, and receive, a Digital Video Broadcast network channel in response to a command; location data logic, operative to receive location data, including geographic coordinates; Digital Video Broadcast network reception requirements logic, operatively coupled to the tuner logic and to the location data logic where the Digital Video Broadcast network reception requirements logic is operative to obtain location data, search stored Digital Video Broadcast network requirements data corresponding to the location data; and send a command to the tuner logic to tune to a Digital Video Broadcast network channel indicated by the Digital Video Broadcast network requirements data.

The embodiments herein disclosed also provide a computer readable media including executable instructions for executing on at least one processor, that when executed cause the at least one processor to obtain location data including geographic coordinates; search stored Digital Video Broadcast network requirements corresponding to the location data; and tune to a Digital Video Broadcast network channel indicated by the Digital Video Broadcast network requirements data. The executable instructions when executed may further cause the at least one processor to determine that a needed Protocol Stack is not present in a memory; request the needed Protocol Stack from a communication network associated with the geographic coordinates; and download the needed Protocol Stack code from the communications network.

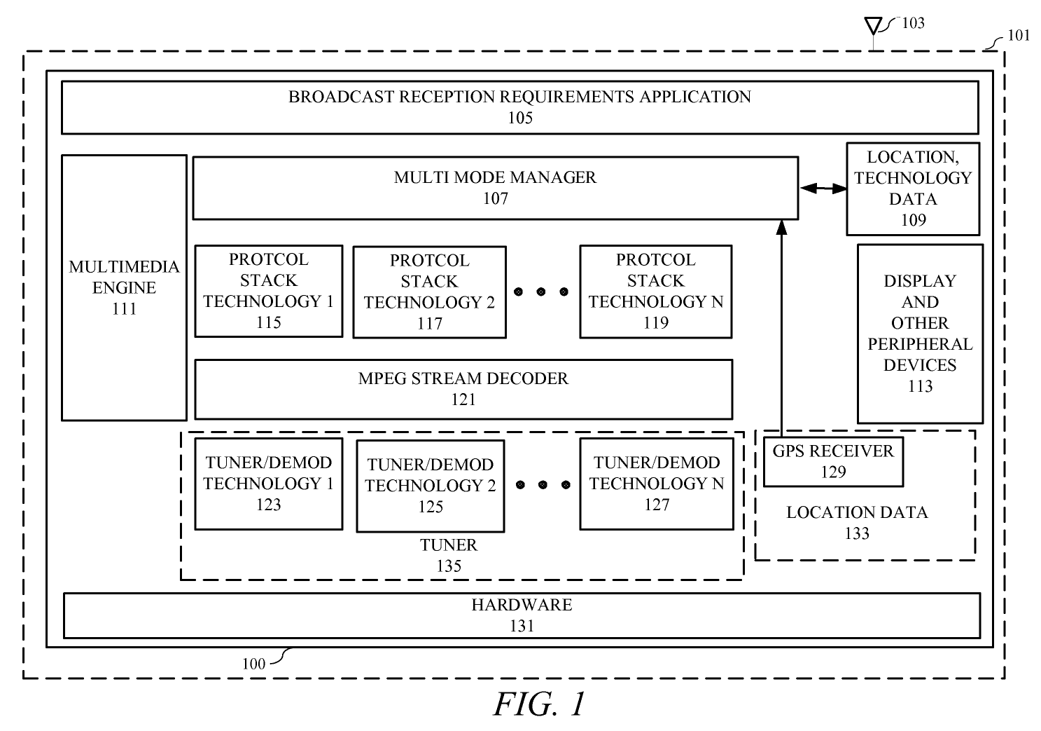

Turning now to the drawings wherein like numerals represent like components FIG. 1 illustrates a mobile station 101 in accordance with the embodiments. The mobile station 101 includes an antenna or antennas 103 for communicating with a telecommunications network and also for communicating with a Digital Video Broadcast network. The Digital Video Broadcast network may be any suitable Digital Video Broadcast network using any suitable Digital Video Broadcast network technology. The mobile station 101 may have the capability to communicate with various different Digital Video Broadcast network technologies and also may have the capability to communicate with telecommunications networks utilizing various different protocols and technologies. The mobile station 101 includes various components 100 which may, in some embodiments, be contained within an integrated circuit. The mobile station 101 includes a multi-media engine 111 for providing, for example, digital video on a display such as the display within display and other peripheral devices 113.

The term logic as used herein includes software and/or firmware executing on one or more programmable processors, ASICs, hardwire logic or combinations thereof. The term Protocol Stack, as used herein, refers to software and/or firmware for execution on one or more programmable processors and/or dedicated processors, or combinations thereof.

All or most of the components illustrated in FIG. 1 are operatively coupled to each other. That is, all of the devices may communicate with each other by, for example, a communication bus (not shown) running through the mobile station 101 circuits and systems. It is to be understood therefore that FIG. 1 is for illustration purposes only, and is not to be construed as a complete schematic diagram of a mobile station or integrated circuit. FIG. 1, as well as the other figures included in the present disclosure, are for the purpose of describing, to one of ordinary skill in the art, the various requirements for making and using the embodiments herein disclosed and, therefore, are limited to such components necessary to facilitate such understanding. Therefore various other components and/or systems, that are not shown in the figures, may be required to provide a complete mobile station or integrated circuit as would be understood by one of ordinary skill in the art.

Therefore the mobile station 101 includes hardware 131, which may further include components such as, but not limited to, receiver front ends, ASICs, and other components necessary for the transmission and reception of wireless signals to and from various communications networks. The hardware 131 is operatively coupled to a tuner logic 135. The tuner logic 135 provides the mobile station 101 with the capability of tuning and receiving Digital Video Broadcasts from various networks utilizing various Digital Video Broadcast technologies. Thus, tuner logic 135 may include various tuner/demodulators for various tuner/demodulator technologies. For example, tuner logic 135 may include a tuner/demodulator technology 123, a tuner/demodulator for a technology 125, up to an nth tuner/demodulator for an nth technology such as tuner/demodulator 127. The tuner logic 135 in the various embodiments may be implemented in hardware, software, or combinations thereof, as was discussed above with respect to usage of the term “logic.”

The tuner logic 135 is further operatively coupled to an MPEG stream decoder 121. The MPEG stream decoder 121 is used for providing video to the display and other peripheral devices 113 by decoding MPEG video files. To accommodate the various Digital Video Broadcast network technologies the mobile station 101 may also include Protocol Stack code for the various Digital Video Broadcast technologies. Each Digital Video Broadcast technology may require a specific Protocol Stack code corresponding to that technology. Therefore, the mobile station 101 may have Protocol Stack code 115 for a first technology, Protocol Stack 117 for a second technology up to and including Protocol Stack 119 for an nth technology. However, the mobile station 101 may not have all needed Protocol Stack codes for all technologies as will be discussed herein. In accordance with the various embodiments the mobile station 101 will include a multi-mode manager 107 operatively coupled to a location technology data 109. The multi-mode manager 107 will be further operatively coupled to a location data logic 133. The location data logic 133 may further include GPS receiver 129, and may also include location server logic, for communicating with a remote location server as is understood by one of ordinary skill. Further in accordance with the various embodiments the mobile station 101 will include broadcast reception requirements logic 105.

The location technology data 109 may be a database, or data tables, relating geographic coordinate data to various Digital Video Broadcast network technologies. Therefore, the broadcast reception requirements logic 105 may obtain location data from the location data logic 133 either directly, or, in some embodiments, via the multi-mode manager 107. The broadcast reception requirements logic 105 may then compare the geographic coordinates received from the location data logic 133 to the information contained in location technology data 109 to determine the broadcast network technology available in the geographic area related to the geographic coordinates obtained via the location data logic 133.

The broadcast reception requirements logic 105 may then cause the tuner logic 135 to tune to a frequency related to the Digital Video Broadcast technology network in the given geographic area wherein the mobile station 101 is presently located.

Among other advantages, the mobile station 101 of the various embodiments need not continuously scan for Digital Video Broadcast networks. Rather, in the various embodiments, the mobile station will have awareness of the present Digital Video Broadcast network by making use of location data received via location data logic 133.

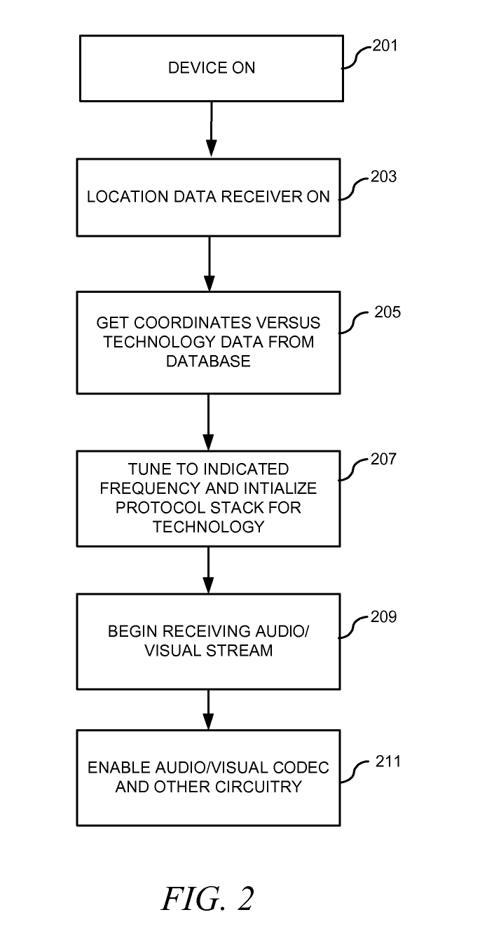

FIG. 2 illustrates operation of the mobile station 101 in accordance with some embodiments. In 201, the mobile station 101 is powered on. For embodiments wherein the location data logic 133 includes a location data receiver, such as, for example, GPS receiver 129, the location data receiver is powered on as shown in 203. In 205 the broadcast reception requirements logic 105 gets the coordinates versus technology data from the stored location technology data 109.

In 207 the broadcast reception requirements logic 105 causes the tuner logic 135, by sending a command to the tuner logic 135, to tune to an indicated frequency and, may also, initialize a relevant Protocol Stack code corresponding to that technology. In 209 the hardware 131 may begin receiving an audio visual stream. In 101 the Protocol Stack code, or the multi-media engine 111, may enable an audio visual codec (not shown) and other circuitry as necessary to provide digital video to the display included in the display and other peripheral devices 113.

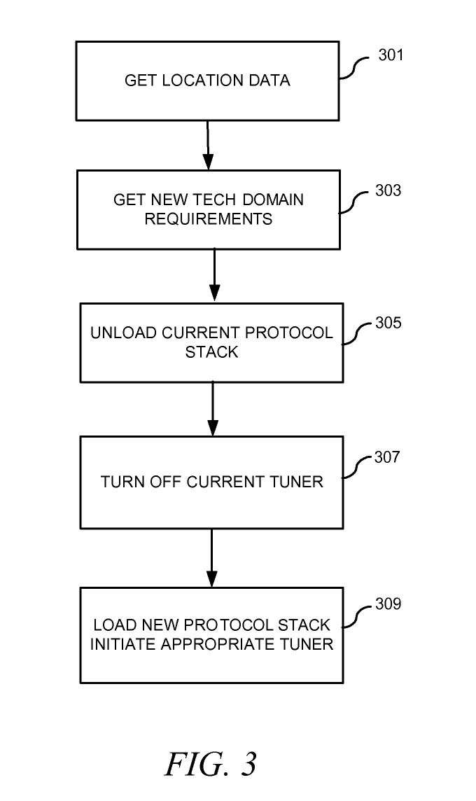

FIG. 3 illustrates operation of the various embodiments as a mobile station moves, or is relocated, to a different geographic location where a different digital video broadcast network technology is present. In 301 the mobile station gets location data, for example location data received by a GPS receiver 129 or by communicating with a location server on, for example, a telecommunications network. In 303 the mobile station gets new technology domain requirements by, for example, comparing the obtained location data with a stored location technology data 109 and performing, for example, a lookup of the coordinates and finding a corresponding digital video broadcast network technology for that geographic area. In 305 the mobile station 101 may unload a currently running Protocol Stack Code. For example, Protocol Stack Code 115 may be unloaded from a processing operation. In block 307 the mobile station may turn off a current tuner. For example the mobile station may turn off tuner 123 of tuner logic 137. In 309 the mobile station 101 may load a new Protocol Stack Code, appropriate for the given technology, and initiate an appropriate tuner. For example the mobile station 101 may load into memory Protocol Stack Code 117 corresponding to technology 2, and turn on tuner/demodulator unit 125 also corresponding to technology 2.

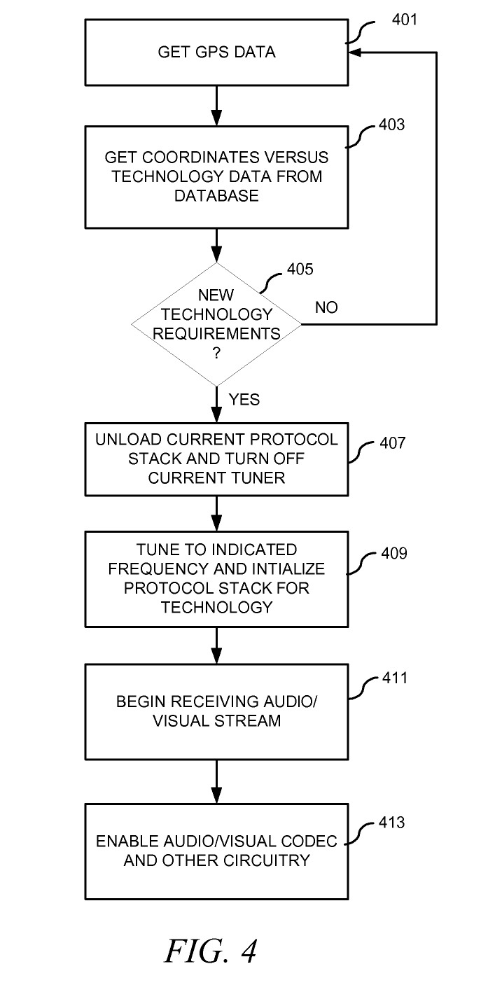

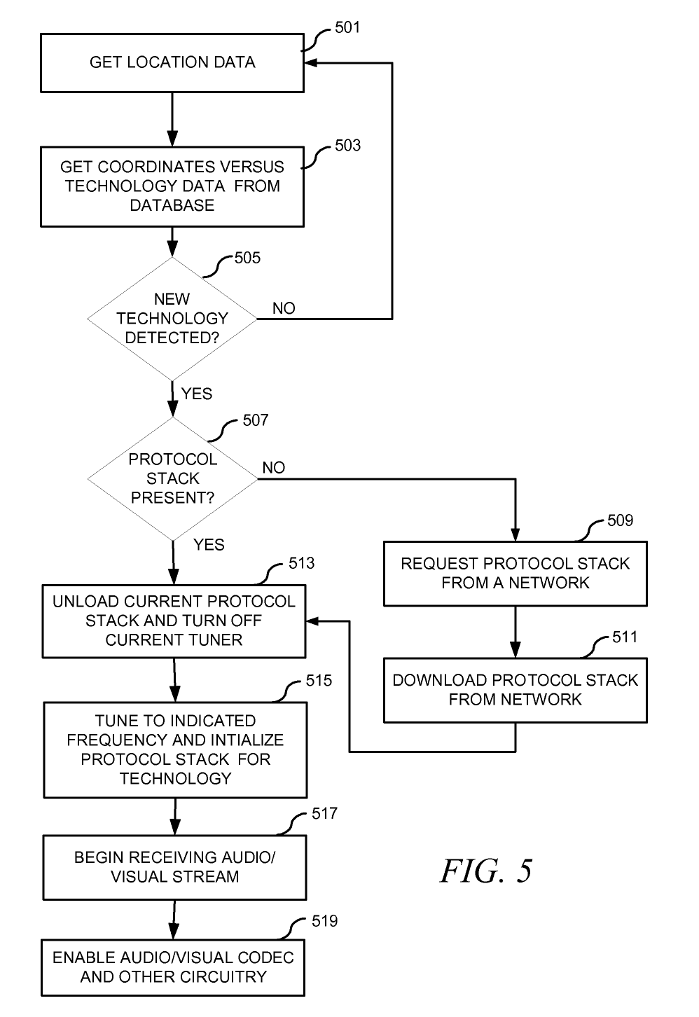

FIG. 4 illustrates operation of embodiments utilizing a GPS receiver such as GPS receiver 129. Therefore in 401 the mobile station accesses the GPS receive 129 and gets a GPS data update including GPS coordinates. In 403 the broadcast reception requirements logic 105 may use the GPS coordinates to perform a lookup in the location technology data 109. If the digital video broadcast network corresponding to the current coordinate set shows that the technology requirements have changed, as shown by decision block 405, then the mobile station may proceed to block 407 where in it will unload a current protocol stack and turn off the current tuner if such Protocol Stack and tuner were running based on a previous digital video broadcast network technology. If no new technology requirements are needed in decision block 405, then the process will again collect the GPS data as shown in 401. In block 409 the broadcast reception requirements logic 105 will cause the tuner logic 135 to tune to an indicated frequency and initialize a Protocol Stack Code relevant to the new technology. In 411 the mobile station may begin receiving an audio visual stream, and in 413 may enable audio visual codecs and other circuitry as required.

FIG. 5 illustrates operations of embodiments wherein the mobile station does not have a needed Protocol Stack Code for communicating with a given digital video broadcast network technology. In block 501 the mobile station gets location data similar to the process described with respect to FIG. 4. The location data may be location data obtained from a location server on a telecommunications network, or may be GPS coordinate data obtained from a GPS satellite system. In 503 the mobile station will compare the coordinates to location technology data 109 to determine the digital video broadcast network technology present in the relevant geographic area. If no new technology is detected in decision block 505, the mobile station will continue to receive location data in 501. However if a new technology is detected, as shown in decision block 505, the mobile station will look for the relevant Protocol Stack Code as shown in decision block 507. If the Protocol Stack Code is present in 507, the mobile station will, in 513, unload a current Protocol Stack Code and turn off a current tuner. In 515 the mobile station, via the broadcast reception requirements logic 105 and the tuner logic 135, will tune to the indicated frequency, and initialize the relevant Protocol Stack, for the present digital video broadcast network technology.

In 517 the mobile station may begin receiving the audio visual stream and, in 519, the mobile station may enable audio-video codecs and other circuitry as needed. However, returning to decision block 507, if the needed Protocol Stack is not present, for example, in a memory of mobile station 101, the mobile station 101 may request the needed Protocol Stack code from a network as shown in block 509. The request for the needed protocol stack code may be made to a telecommunications network such as, but not limited to, a UMTS network, a GPRS network, a GSM network, a CDMA network, or any other appropriate telecommunications network using any appropriate network technology. The mobile station may also request the Protocol Stack code from the digital video broadcast network itself in some embodiments. As shown in block 511, the mobile station may download the Protocol Stack code from the network and return to the process at block 513 thereby proceeding as was described above.

Therefore various methods and apparatuses has been disclosed herein for determining a digital video broadcast network technology utilizing location data, including geographic coordinate data. Among other advantages of the various embodiments, the mobile station may have a reduced setup time for viewing digital video, and may save battery power, by eliminating the need for scanning for various digital video broadcast networks. Other advantages will be apparent to those of ordinary skill in the art.

What is claimed is:

1. A method comprising:
searching stored digital video broadcast network requirements data based on location data including geographic coordinates; and
tuning to a digital video broadcast network channel indicated by said digital video broadcast network requirements data.

2. The method of claim 1, wherein said location data including geographic coordinates, comprises:
Global Positioning System (GPS) data; and
wherein searching said stored digital video broadcast network requirements data based on location data including geographic coordinates comprises:
searching said stored digital video broadcast network requirements data using said GPS data.

3. The method of claim 1, wherein said location data including geographic coordinates, comprises:
location server data; and
wherein searching said stored digital video broadcast network requirements data based on location data including geographic coordinates comprises:
searching said stored digital video broadcast network requirements data using said location server data.

4. A method comprising:
searching stored digital video broadcast network requirements data based on location data including geographic coordinates;
tuning to a digital video broadcast network channel indicated by said digital video broadcast network requirements data; and
initializing a protocol stack code for a digital video broadcast network technology indicated by said digital video broadcast network requirements data.

5. The method of claim 4, further comprising:
determining that said protocol stack code is not present;
requesting said protocol stack code from a communications network associated with said geographic coordinates; and
downloading said protocol stack code from said communications network.

6. The method of claim 4, wherein tuning to a digital video broadcast network channel further comprises:
turning on a tuner circuitry associated with said digital video broadcast network technology and tuning to said digital video broadcast network channel using said tuner circuitry.

7. The method of claim 4, wherein obtaining location data including geographic coordinates, further comprises:
obtaining Global Positioning System (GPS) data; and
searching said stored digital video broadcast network requirements data using said GPS data.

8. The method of claim 4, wherein obtaining location data including geographic coordinates, further comprises:
obtaining location server data; and
searching said stored digital video broadcast network requirements data using said location server data.

9. A mobile communication device comprising:
tuner logic, operative to tune to, and receive, a digital video broadcast network channel in response to a command;
location data logic, operative to receive location data, including geographic coordinates;
digital video broadcast network reception requirements logic, operatively coupled to said tuner logic and to said location data logic, said digital video broadcast network reception requirements logic being operative to:
obtain location data, including geographic coordinates, from said location data logic;
search stored digital video broadcast network requirements data corresponding to said location data; and
send said command to said tuner logic to tune to a digital video broadcast network channel indicated by said digital video broadcast network requirements data; and
a display, operatively coupled to said tuner logic, said display operative to display digital video received via said tuner logic over said digital video broadcast network channel.

10. The mobile communication device of claim 9, wherein said location data logic further comprises:
at least one of a Global Positioning System (GPS) receiver, or location server data logic, for communicating with a location server to obtain said location data, including geographic coordinates; and
memory for storing said stored digital video broadcast network requirements data.

11. The mobile communication device of claim 9, wherein said location tuner logic further comprises:
a plurality of tuner and demodulation modules, each tuner and demodulation module corresponding to a digital video broadcast network technology.

12. The mobile communication device of claim 9, further comprising:
multi-mode manager logic, operatively coupled to said digital video broadcast network reception requirements logic and to said tuner logic, said multi-mode manager logic operative to control said tuner logic and manage initialization and shut down of a plurality of protocol stack codes, each protocol stack code of said plurality of protocol stack codes being associated with a specific digital video broadcast network technology; and wherein said digital video broadcast network reception logic initializes a specific protocol stack code for a corresponding digital video broadcast network technology via said multi-mode manager logic.

13. The mobile communication device of claim 12, wherein said digital video broadcast network reception requirements logic is further operative to:
determine that a needed protocol stack code is not present in a mobile communication device memory;
request said needed protocol stack code from a communications network associated with said geographic coordinates; and
download said needed protocol stack code from said communications network.

14. The mobile communication device of claim 12, wherein said location tuner logic further comprises:
a plurality of tuner and demodulation modules, each tuner and demodulation module corresponding to a digital video broadcast network technology; and wherein said multi-mode manager logic is operative to turn on a specific tuner and demodulation module, of said plurality of tuner and demodulation modules, said specific tuner and demodulation module being associated with said digital video broadcast network technology and tune to said digital video broadcast network channel using said specific tuner and demodulation module.

15. An integrated circuit comprising:
tuner logic, operative to tune to, and receive, a digital video broadcast network channel in response to a command;
location data logic, operative to receive location data, including geographic coordinates;
digital video broadcast network reception requirements logic, operatively coupled to said tuner logic and to said location data logic, said digital video broadcast network reception requirements logic being operative to:
obtain location data, including geographic coordinates, from said location data logic;
search stored digital video broadcast network requirements data corresponding to said location data; and
send said command to said tuner logic to tune to a digital video broadcast network channel indicated by said digital video broadcast network requirements data.

16. The integrated circuit of claim 15, wherein said location data logic further comprises:
at least one of a Global Positioning System (GPS) receiver, or location server data logic, for communicating with a location server to obtain said location data, including geographic coordinates.

17. The integrated circuit of claim 15, wherein said location tuner logic further comprises:
a plurality of tuner and demodulation modules, each tuner and demodulation module corresponding to a digital video broadcast network technology.

18. The integrated circuit of claim 15, further comprising:
multi-mode manager logic, operatively coupled to said digital video broadcast network reception requirements logic and to said tuner logic, said multi-mode manager logic operative to control said tuner logic and manage initialization and shut down of a plurality of protocol stack codes, each protocol stack code of said plurality of protocol stack codes being associated with a specific digital video broadcast network technology; and wherein said digital video broadcast network reception logic initializes a specific protocol stack code for a corresponding digital video broadcast network technology via said multi-mode manager logic.

19. The integrated circuit of claim 15, wherein said digital video broadcast network reception requirements logic is further operative to:
determine that a needed protocol stack code is not present in a mobile communication device memory;
request said needed protocol stack code from a communications network associated with said geographic coordinates; and
download said needed protocol stack code from said communications network.

20. A computer readable media comprising:
executable instructions, for executing on at least one processor, that when executed cause said at least one processor to:
obtain location data including geographic coordinates;
search stored digital video broadcast network requirements data corresponding to said location data; and
tune to a digital video broadcast network channel indicated by said digital video broadcast network requirements data.

21. The computer readable media of claim 20, wherein said executable instructions, when executed, further cause said at least one processor to:
determine that a needed protocol stack code is not present in a memory;
request said needed protocol stack code from a communications network associated with said geographic coordinates; and
download said needed protocol stack code from said communications network.
